(19) United States
(12) Patent Application Publication
(10) Pub. No.: US 2011/0191218 A1
(43) Pub. Date: Aug. 4, 2011

(54) MOBILITY BILLING AND TRACKING APPLICATION FOR SMART CELLULAR PHONES AND PHONES WITH THIS CAPABILITY

(75) Inventor: Floyd Orson Muir, Conyers, GA (US)

(73) Assignee: PR & M ENTERPRISES, LLC., Conyers, GA (US)

(21) Appl. No.: 13/019,611

(22) Filed: Feb. 2, 2011

Related U.S. Application Data
(60) Provisional application No. 61/300,555, filed on Feb. 2, 2010.

(51) Int. Cl. G06Q 10/00; G06Q 30/00

(52) U.S. Cl. 705/32

(57) ABSTRACT

A billing and tracking application is provided for adding new clients, billing clients, creating estimates, tracking time, creating invoices, entering expenses and payments on smart cellular phones such as a Blackberry® phone. The phone in which this application is installed and the computer to which the information is sent is also disclosed. This allows a user to organize and manage their finances and manage their time away from the office.

This application is a utility application that claims priority to co-pending U.S. Provisional Patent Application entitled, “Mobility Billing and Tracking Application for Blackberry® Phones”, having Ser. No. 61/300,555, filed Feb. 2, 2010 which is entirely incorporated herein by reference.

### FIELD OF THE INVENTION

The present invention discloses an application for billing clients, creating estimates, invoices and billing, entering expenses and tracking time on cellular phones, such as Blackberry® phones. This invention is especially useful for small business owners to organize and manage their finances and manage their time.

### BACKGROUND OF THE INVENTION

The prompt billing of clients is essential to small businesses and they many times do not have the resources to timely bill clients for their services. Many of them do not have an internal bookkeeper that handles the billing process. Throughout the work week, small businesses may generate numerous estimates and invoices, but experience shows they struggle to recall these documents in mobile “on the go” environments. The intention for the development of the application is to create a financial tracking application for on the go users.

The invention addresses areas where Small to Midsize Enterprises (SMEs) could benefit from receiving assistance in their day-to-day operations. The most popular areas requiring intervention are in receivables management and in client tracking and invoicing. Another area for enhancement was seen in the creation and delivery of estimates. Whereas internal/external bookkeepers or financial accountants mainly handle the procurement process in these companies, this action requires someone to stop to generate a paper document from a computer. Tracking billable hours and expenses spent on projects while being mobile was also challenging for SMEs.

The method and system of this invention enable on the go SMEs to create and send billing via email/WAP to customers. Upon receipt of the client's bill, customers have the option to access invoices and select a payment option through a designed payment computer or a web services payment system. When the customer pays, the account balance is updated and shows up on the mobile device the next time the user logs in.

Many times it is desirable to get a bill to a client as soon as the services are rendered. The likelihood of the client paying is higher the sooner the bill arrives. It is very important for small businesses to manage their time efficiently as they are frequently understaffed. It is especially important for the owner as his or her time is the most valuable of anyone in the business. The success or failure of the business is frequently dependent on the efficient time management of the owner.

### SUMMARY OF THE INVENTION

Methods and systems with this invention provide the means to create customer information management that track billing and payment activity via a mobile device, such as a cellular smart phone.

In an illustrative example, the mobile application is loaded on the user's mobile device. To access the application, the user logs into the system via a mobile device. The user will have following text fields to enter the information for accessing his/her Web Service account data:

### ‘Sub Domain’

‘Sub Domain’ is derived from the Web Service's account URL (If the login page URL is ‘mycompany.WebService.com’ then subdomain is ‘mycompany’.)

These fields can later be accessed and edited via Settings screen. The menu driven invention allows users to select from two very straightforward setup options. The initial set up of the invention will enable the user to have the flexibility to access their Account from the Internet web service or directly from their phone. From the set up menu, the user can set up the Client contacts. The method and system in this invention enables setting up their invoicing, estimate and time management templates. The Home Screen displays the following options to the user:

1. Clients: To navigate to the ‘Clients’ Screen
2. Invoices: To navigate to the ‘Invoices’ Screen
3. Estimates: To navigate to the ‘Estimates’ Screen
4. Expenses: To navigate to the ‘Expenses’ Screen
5. Time Entries: To navigate to the ‘Time Entries’ Screen
6. Expense Categories: To navigate to the ‘Expense Categories’ Screen
For new clients, here is the Fields to be displayed on the screen:
1. Organization name
2. First name
3. Last name
4. Email (Mandatory field)

### 5. Billing Address: Street Addresses, City, Province/State, Postal/Zip, Country

### 6. Secondary Address: Street Addresses, City, Province/State, Postal/Zip, Country

Save Button: If the server responds with success, the following message is displayed: “Your client has been created.”
Import Contact: Open up the Contact list from the mobile device, which the user can select the desired contact to import. After selecting a contact the fields that exist in selected mobile device Contact (e.g. first name, last name, phone number etc.) will be filled up on the ‘New Client’ screen.
For estimates, a list of the estimates that belong to the logged in user's client (if the user is a staff member) or all the clients (if the logged in user is an admin) can be seen on the screen when this option is selected.
Staff can access the screen if the Estimates tab is enabled for staff.
Each item in the list contains:

### 1. Organization Name

### 2. Estimate Number

### 3. Date of Issue

### 4. Amount due (in USD)

5. Status (invoiced, draft etc.)
Estimates can be converted to invoices. Convert to Invoice:
On selecting this menu item, user is presented with a new screen with the following two options:
a) One time Invoice
On selecting this option, the estimate is converted to one time in-voice application program interface (API call: invoice. Create) and added to Invoice tab of the In-voice screen.

### b) Recurring Invoice

On selecting this option, the estimate is converted to recurring type invoice (API call: recurring. Create) and added to Recurring tab of the Invoice screen. Further, estimates can be edited by doing the following actions:
Add item: Selecting Add Item, a user is taken to a new screen in which the user is required to enter Item name, description of item, unit cost, quantity, taxes
Add Time entry: Selecting Add time entry, a user is taken to a new screen in which the user is required to enter time, entry notes, rate, hours, and taxes
   The web service updates upon receipt of edits and deletions by doing the following:

Edit button:

If the server responds with a success, the following message is displayed: “Your estimate has been updated.”

Delete button:

If the server responds with a success, the following message is displayed: “Estimate has been deleted.”

The estimates list is updated.

In the case of invoices there is a bar consisting of two tabs:
Invoices (Selected by default): To display a list of all invoices
Recurring: To display a list of all ‘Recurring’ type invoices
   Each item in the list (Invoices/Recurring) display following items:
Organization name
Invoice number
Date of Invoice
Amount due (in USD)
Status (invoiced, draft etc.)
   (Staff has access to this screen if the Invoices tab is enabled for staff. Staff users can only access invoices that belong to clients they are assigned to. 1
   Invoices like converted estimates carry out the same functions as expressed above. However, invoices have a filter feature that places each invoice in a category based on status. See below for a listing of invoice status types.
   Filter: Filter menu item has following sub menu items

Disputed: sorts Invoices according to dispute status.

Draft: sorts Invoices according to draft status

Sent: sorts Invoices according to sent status

Viewed: sorts invoices according to viewed status

Paid: sorts invoices according to paid status

Auto-Paid: sorts invoices according to auto-paid status

Retry: sorts invoices according to retry status

Failed: sorts invoices according to failed status

Unpaid: sorts invoices according to unpaid status

Once the invoice is created and saved, payments are categorized by invoice ID, and can be sorted by payment history. Payments can be sent to customers via email or WAP, and through the web service payment options, customers can pay directly. When payment is made, the web services account is updated and the new balance appears on the mobile device the next time the user logs in. On selecting enter payments, the user is taken to Enter Payment Screen having the following fields for the user to fill/select:

### a) Payment Amount

### b) Payment Method

c) Date of payment

### d) Notes

### BRIEF DESCRIPTION OF DRAWINGS

FIG. 1 is a drawing of the home page of a Blackberry® phone.

FIG. 2 is a drawing of a Blackberry® phone showing an estimate on the screen.

FIG. 3 is a drawing of a Blackberry® phone showing the invoice page on the screen.

FIG. 4 is a drawing of Blackberry® phone showing the expense screen.

FIG. 5 is a drawing of Blackberry® phone showing the time entry screen.

FIG. 6 is the schematic diagram illustrating a system which keeps track of clients; creates invoices, estimates, time entry, expenses and other procurement activity via a mobile phone that communicates with a computer or web service.

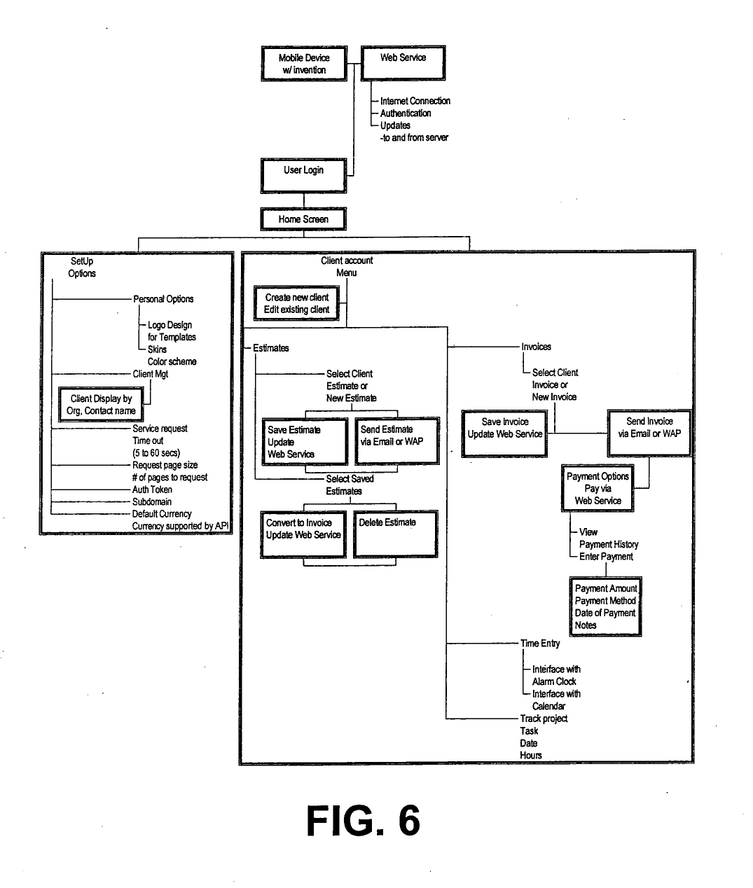

FIG. 7 is a schematic diagram illustrating the payment process and it's interrelationship with the computer or web.

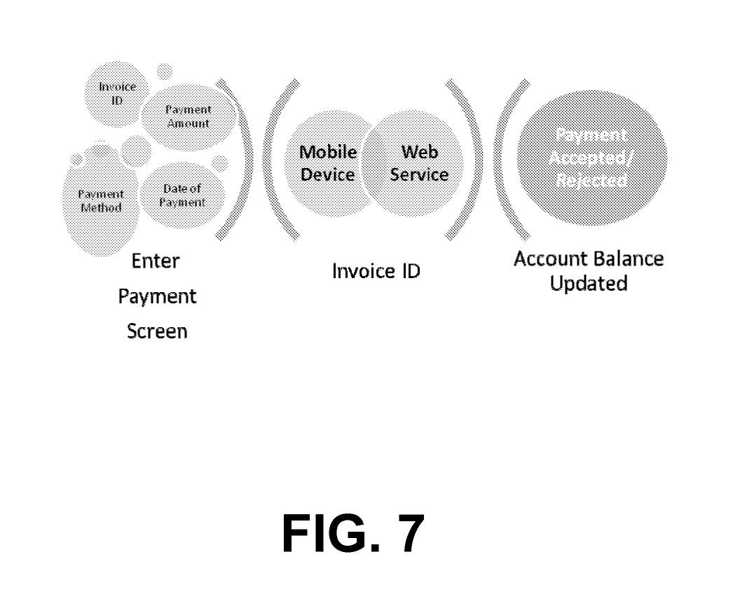

### DETAILED DESCRIPTION OF THE INVENTION

The mobility billing and tracking application (MBTA) of this invention provides an entire system for billing of clients, providing estimates of costs to clients, producing bills or invoices for clients, entering expenses, and keeping track of time of the owner and others working for the business. The MBTA will track financial information. The time management is synchronized with the phone's alarm clock function.

The MBTA can also be adapted to be used with other phones than the Blackberry® operating systems and phones using the Windows 7 operating system, Palm Web OS, Android, I Phones, Nokia, and Symbian OS. The MBTA is especially designed for the Blackberry® phone.

The software for the billing and tracking system application of this invention can be downloaded from the web into a Blackberry® phone or another smart cellular phone. This website will need security in order to protect the unauthorized downloading of this application into a smart phone. The wireless phone will also have a log in and password in order to prevent access to this billing and tracking application by unauthorized users.

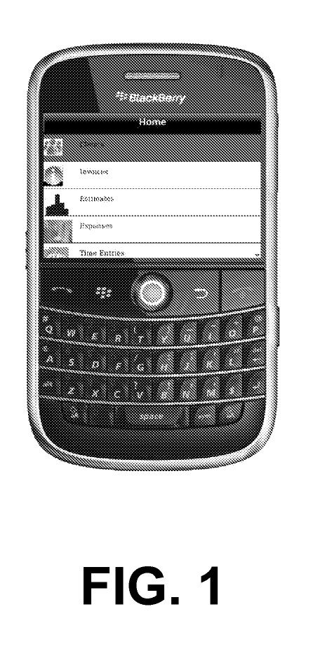

FIG. 1 is a drawing of a Blackberry phone showing the four main functions that the billing and tracking system can perform. These functions are creating invoices and estimates, billing and listing expenses and putting in time entries.

Once the billing and tracking application has been downloaded into a smart cellular phone, such as a Blackberry®, an invoice can be created by the user of the phone by simply typing the invoice on the Blackberry®. In the case of an invoice, the invoice can be sent by email to a client or the invoice can be shown to the client from the screen of the Blackberry®. The invoice can be transmitted to the central computer which can then generate a physical invoice or send the invoice by PDF or other means to the client. The invoice and other documents created on the smart phone will be stored in the computer. The invoice of course can be managed and changed by the central computer before it is actually sent to the client. It could also be changed by the user of the Blackberry® upon showing the invoice to the client on the screen of the Blackberry® or sending by email to the client.

It is important to realize that the smart phone such as the Blackberry® is connected to a central computer where all of the information is stored.

The smart phone utilizes the native clock of the phone for keeping track of time which may be one of the ways in which the amount of the invoice or time is determined. Other items such as supplies, etc. can be entered on the invoice and the smart phone. It is extremely important that the invoice be integrated with the smart phones.

Preferably the storage in the computer will be done in files such as a file for invoices and a file for estimates and other items that the billing and tracking application is capable of handling. The invoice of course can be managed and changed by the central computer before it is actually sent to the client. It could also be changed by the user of the Blackberry upon showing the invoice to the client on the screen of the Blackberry® or sending by email to the client.

Other items such as supplies, etc. can be entered on the invoice and the smart phone. It is extremely important that the invoice be integrated with the smart phones user's accounting system.

Payment can be entered into the system to change the balance of the accounts receivable.

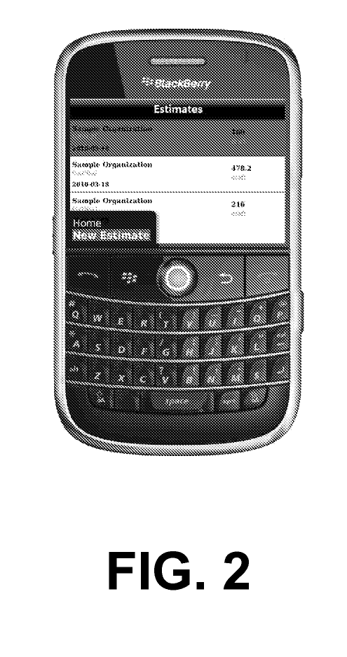

FIG. 2 shows the estimate screen for a Blackberry®. The estimate can be created by the user of the phone by typing in the estimate. The calculator on the phone can be used to make any computations that are necessary. This estimate can be sent to the client by email or the screen can be shown to the client if the estimate is made in the presence of the client. This estimate is sent to the central computer and stored, preferably in a file of estimates. This application will produce new estimates or revise old estimates that have been given previously to the client. The estimate can be saved in the memory on the phone and later saved on the central computer or sent to the central computer at the same time the estimate is created on the phone.

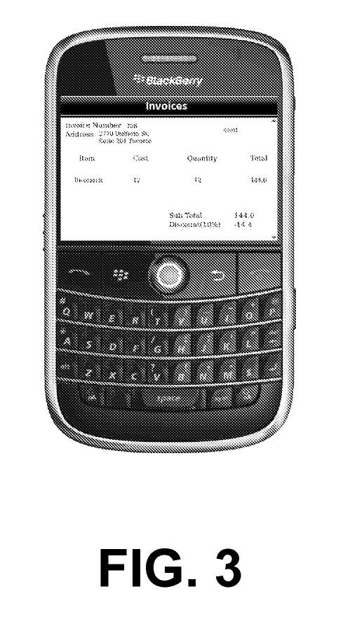

FIG. 3 shows the screen of a Blackberry® with a sample invoice. The Blackberry® can store the necessary information on the client and the invoice numbers and the invoice can be typed in by the user of the Blackberry® or other smart phones. This invoice can be sent by email to the client and also sent to the central computer. The invoice can be stored on the Blackberry®. The invoice can be sent to the client by email or from the computer by PDF or other means.

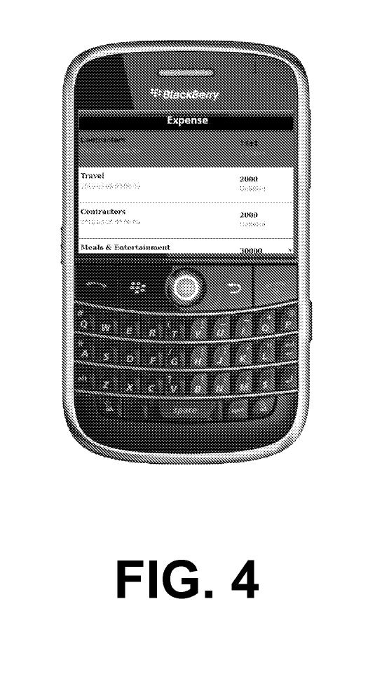

One of the major problems of a smart phone user who travels is keeping track of expenses. FIG. 4 shows a screen of expenses where various expenses can be entered into the Blackberry® and conveyed back to the central computer. This expense screen can be entered at the time the expense is incurred so it is not necessary to create a separate expense report. The client name or client number can be entered on the expense report so that a written report can be automatically generated by the central computer.

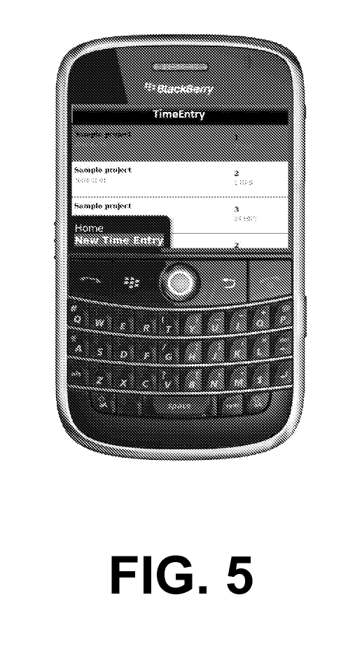

Many professionals bill upon the time spent. FIG. 5 allows the time to be entered. This utilizes the native clock in the phone. The name of the client or the client number can be entered in connection with the time. This information can be conveyed back to the central computer and used to generate an invoice based upon the time of a phone call on the smart phone. This can be entered and also list the client information.

This application will also allow the user of the phone to enter a payment by credit card or cash by entering it into the smart phone which will be conveyed back to the computer. The credit card information can be entered into the phone and will be protected by the security features of the phone for this application.

It is important to keep in mind that the central computer is an important part of this application and that it can reconcile invoices and also point out inconsistencies between information entered in the smart phone and present in the computer. A cash payment made to the user by a client can also be entered in the smart phone and an email receipt sent by the phone to the client or from the computer.

For purposes of security of this application, it may have a separate login and password than that from the phone itself.

The data that is entered in the smart phone can be placed on the web which is protected by security for viewing by the client.

### APPLICATION TECHNICAL DESIGN

The design of the application is set forth below:

### MBTA Blackberry Application Technical Design Screens:

### 1.1 Login Screen

This screen will be displayed only once for the first time entry into the application.
It will have following text field for a user to enter the information for accessing his/her account data:
‘Sub Domain’
   ‘Sub Domain’ is derived from the account URL (If the login page URL is ‘mycompany.com’ then subdomain is ‘mycompany’.)
   This field can later be accessed and edited via Settings screen.

### Buttons:

‘Let's Go’: Clicking this button, will use the token for basic HTTP authentication and will store this information in the applications internal database.

### 1.2 Home Screen

This screen will display the following options to the user:

1. Clients: To navigate to the ‘Clients’ Screen

2. Invoices: To navigate to the ‘Invoices’ Screen

3. Estimates: To navigate to the ‘Estimates’ Screen

4. Expenses: To navigate to the ‘Expenses’ Screen

5. Time Entries: To navigate to the ‘Time Entries’ Screen

6. Expense Categories: To navigate to the ‘Expense Categories’ Screen

### 1.3 Clients Screen

Fields to be displayed on the screen:
A list of the clients that are already added for the logged in users company
Each item in the list contains:

### a) Client's Name

### b) Client's Organization Name

### List Item Click Event:

Navigate to: ‘Client's Details’ screen.

Menu Items and their Click Events:

### Home:

Navigate to: ‘Home’ Screen

### New Client:

Navigate to: ‘New Client’ Screen

### 1.3.1 Client's Details Screen

Fields to be displayed on the screen:

1. Organization name

2. Name

3. Email

4. Billing Address: Street Addresses, City, Province/State, Postal/Zip, Country

5. Contact numbers: Work Contact no., Home Contact no., Fax no.

6. Credit Information—This is only required for clients with recurrent billing. This information is optional

Menu Items and their Click Events:

### Home:

Navigate to: ‘Home’ Screen

### Edit Client:

Navigate to: ‘Edit Client’ Screen

### 1.3.2 New Client Screen

Fields to be displayed on the screen:

1. Organization name

2. First name

3. Last name

4. Email (Mandatory field)

5. Billing Address: Street Addresses, City, Province/State, Postal/Zip, Country

6. Secondary Address: Street Addresses, City, Province/State, Postal/Zip, Country

Save Button: If the server responds with success, the following message is displayed:

“Your client has been created.”

Menu Items and their Click Events

### Home: Navigate to: ‘Home’ Screen

Import Contact : Open up Blackberry Contact list from which the user can select the desired contact to import. After selecting a contact the fields that exist in selected Blackberry® Contact (e.g. first name, last name, phone number etc.) will be filled up on the ‘New Client’ screen.

### 1.3.3 Edit Client Screen

Fields to be displayed on the screen:

1. Organization name

2. First name

3. Last name

4. Email

5. Billing Address: Street Addresses, City, Province/State, Postal/Zip, Country

6. Secondary Address: Street Addresses, City, Province/State, Postal/Zip, Country

### Notes

### Buttons:

### Edit Button:

if the server responds with a success, following message is displayed “Your client has been updated.”

### Delete Button:

If the server responds with a success, the following message is displayed “Your client has been deleted.”

Menu Items and their Click Events:

### Home Navigate to: ‘Home’ Screen

### 1.4 Estimates Screen

Fields to be displayed on the screen:
A list of the estimates that belong to the logged in user's client (if the user is a staff member) or all the clients (if the logged in user is an administrator).
Staff can access the screen if the Estimates tab is enabled for staff.
Each item in the list contains:

1. Organization Name

2. Estimate Number

3. Date of Issue

4. Amount due (in USD)

5. Status (invoiced, draft etc.)

### List Item Click Event:

Navigate to: ‘Estimate Details’ screen.

Menu Items and their Click Events:

### Home Navigate to: ‘Home’ Screen

### 1.4.1 Estimate Detail Screen

Fields to be displayed on the screen:

1. Estimate number

2. Estimate status (sent, invoiced, partial etc.)

3. Client's Address: Organization name, Street addresses, City, Province/state, Postal/zip, Country

4. Table with following data fields:
Item
Description
Cost
Quantity
Total

5. Subtotal

6. Taxes applied

7. Total

8. Amount Paid

9. Balance due (in USD)

10. Terms

11. Notes

Menu Items and their Click Events:

### Home

Navigate to: ‘Home’ screen

### Convert to Invoice:

On selecting this menu item, user is presented with a new screen with the following two options:

a) One time Invoice
On selecting this option, the estimate is converted to one time invoice (Application Program Interface, API call: invoice. Create) and added to Invoice tab of the Invoice screen.

b) Recurring Invoice

On selecting this option, the estimate is converted to recurring type invoice (API call: recurring. Create) and added to Recurring tab of the Invoice screen.

### Edit Estimate:

Navigate to: ‘Edit Estimate’ screen

### 1.4.2 Edit Estimate Screen

Fields to be displayed on the screen:

1. Organization: Drop down menu consisting of all organizations

2. Address: Address corresponding to selected organization

3. Estimates Details: Estimate number, Date of issue, PO number, Discount %

4. Dropdown list consists of following items:
Add item: Selecting Add Item, a user is taken to a new screen in which the user is required to enter Item name, description of item, unit cost, quantity, taxes
Add Time entry: Selecting Add time entry, a user is taken to a new screen in which the user is required enter time entry notes, rate, hours, and taxes

On returning from new screen, the new item/time entry is added to Edit Estimate Screen.

5. Subtotal

6. Total

7. Amount Paid

8. Balance due

9. Terms

10. Notes

### Buttons:

Edit button:

If the server responds with a success, the following message is displayed: “Your estimate has been updated.”

Delete button:

If the server responds with a success, the following message is displayed: “Estimate has been deleted.”

The estimates list is updated.

Menu Items and their Click Events:

### Home

Navigate to: ‘Home’ screen

### 1.5 Invoices Screen

Fields to be displayed on the screen:

1. A tab bar consisting of two tabs:
Invoices(Selected by default): To display a list of all invoices
Recurring: To display a list of all ‘Recurring’ type invoices

Each item in the list (Invoices/Recurring) display following items:
Organization name
Invoice number
Date of Invoice
Amount due (in USD)
Status (invoiced, draft etc.)
   (Staff has access to this screen if the Invoices tab is enabled for staff. Staff users can only access invoices that belong to clients they are assigned to.)

### List Item Click Event:

Navigate to ‘Invoice Details’ screen

Menu Items and their Click Events:

### 1) Home:

Navigate to: ‘Home’ Screen

Menu items 2, 3 are presented only if the ‘Invoice’ tab is selected.

### 2) New Invoice

### Navigate to: ‘New Invoice’ Screen

3) Filter: Filter menu item has following sub menu items

Disputed: sorts Invoices according to dispute status.

Draft: sorts Invoices according to draft status

Sent: sorts Invoices according to sent status

Viewed: sorts invoices according to viewed status

Paid: sorts invoices according to paid status

Auto-Paid: sorts invoices according to auto-paid status

Retry: sorts invoices according to retry status

Failed: sorts invoices according to failed status

Unpaid: sorts invoices according to unpaid status

### 1.5.1 Invoice Details Screen

Fields to be displayed on the screen:

1. Invoice number

2. Invoice status (sent, draft, disputed, viewed)

3. Address: Organization name, Street addresses, city, province/state, postal/zip, country

4. Table with the following data fields:
Item
Cost
Quantity
Total

5. Subtotal

6. Taxes applied

7. Total

8. Amount Paid

9. Balance due (in USD)

10. Menu Items and their Click Events:

### 1) Home:

Navigate to: ‘Home’ Screen

### 2) Edit Invoice

Navigate to: ‘Edit Invoice’ Screen

### 3) Send Invoice:

Send Invoice menu item has three sub menu items:

1) Via Email:

2) Via e-Fax:

3) Via snail mail:

4) 4) View Payment History: Shows all the payments related to this particular invoice id.

### 1.5.2 New Invoice Screen

Fields to be displayed on the screen:

1. Organization: Drop down menu consisting of all organizations (Mandatory field)

2. Address: Address corresponding to selected organization.

3. Invoice Details: Invoice number, Date of Issue, PO number, Discount %

4. Label with text “The Client has outstanding expenses” and an ‘Add to Invoice’ button if the Client has outstanding expenses.
On pressing ‘Add to Invoice’ button the outstanding expense is added as a line entry to invoice.

5. Drop down list consists of following items:
Add item: On selecting Add Item user is taken to new screen in which user is required to enter Item name, description of item, unit cost, quantity, taxes
Add Time entry: On selecting Add time entry user is taken to new screen in which user is required enter time entry notes, rate, hours, and taxes
On returning from new screen, the new item/time entry created is added to

New Invoice Screen.

6. Subtotal

7. Total

8. Amount Paid

9. Balance due

10. Terms

11. Notes: User can enter notes(not visible to client)

### Buttons:

Done button:
If the server responds with a success, the following message is displayed: “Your invoice has been created”
Menu Items and their Click Events:

### Home:

Navigate to: ‘Home’ Screen

### View Payment History:

Shows all the payments related to this particular invoice id.

### 1.5.3 Edit Invoice Screen

Fields to be displayed on the screen:

1. Organization: Drop down menu consisting of all organizations.

2. Address: Address corresponding to selected organization.

3. Invoice Details: Estimate number, Date of Issue, PO number, Discount %

4. Drop down list consists of following items:
Add item: On selecting Add Item user is taken to new screen in which user is required to enter item name, description of item, unit cost, quantity, taxes
Add Time entry: On selecting Add time entry user is taken to new screen in which user is required enter time entry notes, rate, hours, and taxes
On returning from the new screen, the new item/time entry created is added to Edit Invoice Screen.

5. Subtotal

6. Total

7. Amount Paid

8. Balance due

9. Terms

10. Notes

### Buttons:

Edit button: “Your invoice has been updated”
Delete button:
Menu Items and their Click Events:

### Home Navigate to: ‘Home’ Screen

### Enter Payments

On selecting enter payments, user is taken to Enter Payment Screen having the following fields for the user to fill/select:
   a) Payment Amount
   b) Payment Method
   c) Date of payment
   d) Notes
      View Payment History: Shows all the payments related to this particular invoice id.

### 1.6 Expenses Screen

Fields to be displayed on the screen:
A list of expenses with each item in the list displaying:
Expense Category
Date
Amount (in USD)
Status (unbilled, not assigned, invoiced)
   List item click event Navigate to: ‘Expense Detail’ screen
   Menu Items and their Click Events:

### Home: Navigate to: ‘Home’ Screen

### New Expense: Navigate to: ‘New Expense’ Screen

### 1.6.1 Expense Details Screen

Fields to be displayed on the screen:

1. Amount

2. Date

3. Vendor

4. Category

5. Status (unbilled, not assigned, invoiced)

6. Taxes included

Menu Items and their Click Events:

### Home: Navigate to: ‘Home’ Screen

### Edit Expense: Navigate to: ‘Edit Expense’ Screen

### 1.7.1 New Expense Screen

Fields to be displayed on the screen:

1. Amount (Mandatory)

2. Date (Mandatory)

3. Vendor

4. Category (Mandatory)

5. Tax: Drop down list of existing taxes

6. Amount (after applying tax)

7. Assign to Client: Drop down list of existing Clients

8. Project: Drop down list of all the projects for the selected client

9. Notes

Buttons: Add Expense button
Menu Items and their Click Events:

### Home: Navigate to: ‘Home’ Screen

Import from Calendar: User is shown a list of Calendar events, from which he can select any event to import as new expense.

### 1.6.2 Edit Expense Screen

Fields to be displayed on the screen:

1. Amount (Mandatory)

2. Date (Mandatory)

3. Vendor

4. Category (Mandatory)

5. Tax: Drop down list of existing taxes

6. Amount (after applying tax)

7. Assign to Client: Drop down list of existing Clients

8. Project: Dropdown list of all projects of selected client

9. Notes

### Buttons:

### Edit Button:

On pressing ‘Edit’ button a call is made to ‘expense. Required parameters can be obtained from Edit Expense Screen.

### Delete Button:

On pressing ‘Delete’ button a call is made to ‘expense. Delete’. If the server responds with success, then selected expense is deleted and the expense list is updated accordingly. Following message is displayed on successful deletion:
“Expense has been deleted”
Menu Items and their Click Events:

### Home

Navigate to: ‘Home’ Screen

### 1.7 Time Entries Screen

Fields to be displayed on the screen:
A list of expenses with each item in the list displaying:

1. Project (Mandatory)

2. Task (Mandatory)

3. Date (Mandatory)

4. Hours

List item click event

Navigate to: ‘Time Entry Detail’ screen

Menu Items and their Click Events:

### Home

Navigate to: ‘Home’ Screen

### New Time Entry

Navigate to: ‘New Time Entry’ Screen

### 1.7.1 Time Entry Detail Screen

1. Fields to be displayed on the screen:

2. Project (Mandatory)

3. Task (Mandatory)

4. Date (Mandatory)

5. Hours

6. Notes

Menu Items and their Click Events:

### Home

Navigate to: ‘Home’ Screen

### Edit Time Entry

Navigate to: ‘Edit Time Entry’ Screen

### 1.7.2 New Time Entry Screen

Fields to be displayed on the screen:

1. Project: Drop down list consisting all existing project

2. Task: Drop down list consisting of existing tasks

3. Hours

4. Notes

5. Date

### Buttons:

Create button
Menu Items and their Click Events:

### Home:

Navigate to: ‘Home’ Screen

### Edit Time Entry:

Navigate to: ‘Edit Time Entry’ Screen

Import from Calendar:

User is shown a list of Calendar events from which user can select the events he wants to include in the Time entry.

### 1.7.3 Edit Time Entry Screen

Fields to be displayed on the screen:

1. Project: Drop down list consisting all existing project

2. Task: Drop down list consisting of existing tasks

3. Hours

4. Notes

5. Date

### Button:

Edit button:

If the server responds with success, then an alert is shown displaying “Time Entry successfully updated”.

Delete Button: If the server responds with success, then selected time entry is deleted and the time entries list is updated accordingly.

Menu Items and their Click Events:

### Home Navigate to: ‘Home’ Screen

### 1.8 Expense Categories Screen

Fields to be displayed on the screen:
A list of expenses with each item in the list displaying:

### Category Name

List item click event

Navigate to: ‘Category Detail’ screen

Menu Items and their Click Events:

### Home

Navigate to: ‘Home’ Screen

### New Category

Navigate to: New Category Screen

### 1.8.1 Category Detail Screen

Fields to be displayed on the screen:

### Category Name

Menu Items and their Click Events:

### Home

Navigate to: ‘Home’ Screen

### Edit Category

Navigate to: ‘Edit Category’ Screen

### 1.8.2 New Category Screen

Fields to be displayed on the screen:

### Category Name

### Buttons:

Menu Items and their Click Events:

### Home

Navigate to: ‘Home’ Screen

### 1.8.3 Edit Category Screen

Fields to be displayed on the screen:

### Category Name

### Buttons:

Edit button
Menu Items and their Click Events:

### Home

Navigate to: ‘Home’ Screen

### 1.9 Offline Backup

On unavailability of network, all the new invoices, estimates and time entries created will be temporarily stored to a persistent storage of the device. All data updates can be done off-line and synchronized later when the network is available.

### 1.10 SetUp Screen

The following options will be included on the Settings screen. These will be editable by the user at any time

1. Subdomain

2. Authorization

3. Refresh on open (Yes/No)—whether application should refresh entries from the server after user re-enters the application

4. Service request timeout (in seconds)

5. Request page size (0 by default)—number of pages to fetch for a request

6. Client display by (Org, Contact name)

7. Default currency (default USD)

8. e-fax login

9. Tax Settings (maximum 4)—For each tax, the following will be input from the user
a. Tax name
b. Tax percent
c. Government tax ID (optional)

### FEATURES OF THE INVENTION

The invention contains many features including:
Output of the billing invoice, estimate etc. is in the form of an Adobe PDF., or a Comma Delimited File.csv
   Upon completion of the template edit (Estimate, Invoice or Time Mgmt.), the user will have the option to save the file created as a PDF or as a Comma Delimited file (usually used to import into other applications)
Payment processing: application keeps track of payments made by clients.
   When the client logs into the online portal (or if they have mobile account), he/she will be able to see and select payment options.
   The system flags payments that have been made on customer accounts and also deducts from existing balances. This enables the development of additional invoices.
Synching phone's alarm clock with the Time Entry
   Users can keep track of their billable hours, and employers can keep track of time sheets from their employees who have been added to the system
Conversion of Estimates to instant Invoices for billing
   The Invoice feature allows for instant conversion of saved Estimates.
   This feature will request if the Estimate requires Time Entry and if so, the system will apply start and completion times to projects (where applicable).
Invoice sending features (via email or upload to online application)
   Saved invoices (PDF or CSV files) can be saved and sent to clients via:
      Email: Users can send emails or messages with file attachments directly from their phones
      File Upload: This process will require customers to
      Login to their online account from their phone, and upload files online
Easy renewal process
   Multiple license purchase also available during download and installation process
One touch Application upgrades
   Additional application features will be available and sent via email or text message to existing users.
In compliance with current day online/mobile payment processing
   Clients will be able to use their current payment method and access the web service processing systems to receive and provide payment
   When the user sends out billing to clients, they have the option to pay using their existing payment provider
   During upgrade and application renewal, the customer can use their existing payment provider
      Some of the most relevant mobile device features that will interact with this invention are:
Address book
Alarm
Calendar App

Some of the specifications for this system are listed below:
Programming Languages & Platforms
   Java Virtual Machine
   Sun Java FX Phone Edition
Flash Scripting
   Adobe Flash SDK
   Flash Lite
Web Application
   HTML/CSS
   HTML/CSS
   JavaScript (or AJAX)
   Php
   Python
   GPRS
   EDGE
   3G
   UMTS
   Wi-Fi
Mobile Standards
   Open Mobile Alliance (OMA)
   Open Mobile Terminal Platform (OMTP)
   Synchronization for telephony, mobile video, etc. (SyncML)
   GSM
   CDMA
   WiMAX

I claim:

1. A system comprising a computer with wireless capability and having an accounting program; and
a smart cellular phone with a screen into which application software has been downloaded to enable the user of the phone to create detailed invoices, estimates of work costs, do billing, entering expenses, and track time, all of which can be displayed on the screen of the phone and sent wirelessly to the computer with an integrated accounting system into which the detailed invoices, estimates of work costs, billing, expenses and time can be inserted and integrated and which can be sent by email or other wireless protocol by the phone to another party with a smart phone or computer.

2. The system of claim 1 in which the phone is a Blackberry®.

3. A smart cellular phone with a screen into which application software has been downloaded to enable the user of the phone to create detailed invoices, estimates of work costs, do billing, enter expenses, and track time, all of which can be displayed on the screen of the phone and sent wirelessly to a designated computer with an integrated accounting system into which the detailed invoices, estimates of work cost, billing, expenses and time can be inserted and integrated and which can be sent by the phone by email or other wireless protocol to another party with a smart phone or computer.

4. The phone of claim 3 in which the phone is a Blackberry®.

5. Application software designed for downloading into a particular smart cellular phone with a screen, the software having code for allowing the user of the phone to create detailed invoices, estimates of work costs, do billing, enter expenses, and track time, all of which can be displayed on the phone and sent wirelessly to a designated computer with an integrated accounting system into which the detailed invoices, estimates of work costs, bills, expenses and time can be inserted and integrated and which can be sent by the phone by email or other wireless protocol to another party with a phone or computer.

6. The application software of claim 5 in which the phone is a Blackberry®.

7. A mobility billing and tracking application for Blackberry and other mobile phones with a screen, the phone having email or other wireless capability and hardware and software that the application utilizes to allow the user to create detailed invoices, track time, enter expenses, create estimates of costs and bills to be sent wirelessly into a designated computer system and which can be sent by email or other wireless protocol to clients, the application having the necessary software code for interacting with the software and hardware of the phone in order to implement the application, said mobility billing and tracking application utilizing at least the address book, alarm feature, calendar, email, other wireless capability, attachment and computing features of phone.

8. A method to manage customer information, invoice and estimate creation of customer lists, time and expense tracking and other procurement activity via a smart cellular phone with a screen into which application software has been downloaded for creating information, such as detailed invoices, estimates of work cost, billing, expenses, and tracking time utilizing the features of the phone, in which all of the information can be displayed on screen of the phone and sent wirelessly to the computer with an integrated accounting system into which the detailed invoices, estimates of work cost, billing, expenses and time can be inserted and integrated and which can be sent by email or other wireless protocol to another party, the method comprising the user of the phone entering the information in the phone for display on the screen, and if elected by the user of the phone to wirelessly convey the information to a designated computer that is capable of integrating the information into the computer via a smart cellular phone, and electing to convey the information from the phone to another party by email or other wireless protocol to another smart phone or computer.

9. The method of claim 8 in which the phone is a Blackberry.

10. The method of claim 8, where all the new invoices, bills, estimates and time entries created will be temporarily stored in the persistent storage of the phone.

11. The method of claim 8, where customer account information can be retrieved by the user through an application program interface call feature.

12. The method according to claim 8, wherein the entry of a valid email address by the user of the phone is required before the application call interface call feature can create a new customer record populated with selected information about the customer.

13. The method of claim 8 where the user of the phone can delete client information on the designated computer and on the phone at the same time.

14. The method of claim 8, which allows a staff member or administrator, who is not the user of the phone, to retrieve a list of the estimates and invoices on the designated computer that belong to the logged in users client or all the clients

15. The method of claim 8, whereas the user of the phone which has a recurring tab can convert an estimate or invoice to recurring type invoice under the application program interface by adding to recurring tab of the phone screen.

16. The method of 8, in which the application also includes a filter for filtering invoices as they are retrieved from the designated computer by the phone user; where the invoice status is listed as disputed, draft, sent, viewed, paid, auto-paid, retry, failed, unpaid, and the filter sorts invoices according to that specific status.

17. The method of claim 8, in which the application also includes a method so the user of the phone can view the payment history can be seen on the screen of the phone based on invoice ID.
